(19) United States
(12) Patent Application Publication
(10) Pub. No.: US 2014/0106307 A1
(43) Pub. Date: Apr. 17, 2014

(54) Method, Transfer Device and Template Body for Producing a Dental and/or Bone Prosthesis for a Dentition

(71) Applicants: Michael KRISCHOLLEK, (US); Tridenta Dentaltechnik GmbH, Berlin (DE)

(72) Inventors: Frank JASPER, Berlin (DE); Viola ILLMER, Berlin (DE); Michael KRISCHOLLEK, Berlin (DE)

(73) Assignee: Tridenta Dentaltechnik GmbH, Berlin (DE)

(21) Appl. No.: 14/050,647

(22) Filed: Oct. 10, 2013

(30) Foreign Application Priority Data
Oct. 11, 2012 (EP) EP 12 188 176.7

(51) Int. Cl. A61C 13/34; A61C 9/00; A61C 13/08; A61C 13/00; A61C 11/00

(52) U.S. Cl. CPC A61C 13/34; A61C 13/0006; A61C 11/00; A61C 13/08; A61C 9/0053
USPC 433/202.1; 433/213

(57) ABSTRACT

Disclosed herein is a method for producing a dental and/or bone prosthesis for a dentition having a defect, comprising: determining the left and right direction point and an induction point of the upper jaw as three cranial reference points of the upper jaw and determining the left and right direction point and an induction point of the lower jaw as three cranial reference points of the lower jaw; creating a model of the defective dentition, one model half produced for the upper jaw and one model half produced for the lower jaw; identifying the three cranial reference points of the upper jaw on the upper jaw model half and identifying the three cranial reference points of the lower jaw on the lower jaw model half; arranging and fixing the upper jaw model half and the lower jaw model half relative to one another; forming the dental and/or bone prosthesis.

### BACKGROUND OF THE INVENTION

1. Field of the Invention

The invention relates to a method for producing a dental and/or bone prosthesis for a dentition having a defect, to a template body and to a transfer device for producing the dental and/or bone prosthesis.

2. Description of the Related Art

A dentition having a defect is usually provided with a dental and/or bone prosthesis so as to compensate the functional deficiency resulting from the defect as completely as possible. The defect may be the result of abrasion of the chewing surfaces, loss of a tooth or a plurality of teeth or a complete row of teeth. Further, the defect in the dentition may be accompanied by a jaw fracture, a loss of bone or a deformation of the whole skull. When producing the dental and/or bone prosthesis, a model of the defective dentition is conventionally created, the upper jaw and the lower jaw of the dentition being modelled accordingly. Conventionally, this model may be a plaster model or exist virtually as a computer model.

The lower jaw is articulated to the upper jaw via the temporomandibular joint, the defect in the dentition causing the position of the lower jaw and the teeth thereof relative to the upper jaw and the teeth thereof to be in a position other than the ideal position. The resulting mispositioning may for example lead to damage to the entire joint and backbone system, in particular to craniomandibular dysfunctions (CMDs) and, in connection therewith, to muscular tensions and headaches, which may impair the affected individual's sense of wellbeing. The problem is that when the dental and/or bone prosthesis is produced, the dentition is only available with the defect, and therefore the ideal position of the lower jaw relative to the upper jaw cannot be fully reconstructed.

Conventionally, it is known to approximate the position of the lower jaw relative to the upper jaw by means of a jaw model, maximally optimal positioning of the lower jaw relative to the upper jaw being attempted by way of empirically acquired data. However, one-to-one positioning of the lower jaw relative to the upper jaw is not possible with this procedure, and degrees of freedom remain. As a result, the quality of the dental and/or bone prosthesis to be produced depends on the skill and experience of the dental technician in finding a positioning of the lower jaw relative to the upper jaw which comes as close as possible to the ideal position.

As an aid for this purpose, the dental technical may turn to the “Staub-Cranial” analysis and production system, by means of which the positioning of the lower jaw model relative to the upper jaw model can be approximated using specific anatomical data (“Staub-Cranial-System—Reliabilität der Messpunkte zur Rekonstruktion zur Zahnstellung im zahnlosen Kiefer”, inaugural dissertation at the Albert Ludwigs University of Freiburg im Breisgau, Panagiotis Lampropoulos, 2003). The Staub-Cranial system is based on anatomical cranial reference points on the upper jaw and the lower jaw. The upper jaw and the lower jaw each have four cranial reference points, each jaw having a right and left direction point and a front and rear induction point. The direction points are located in the molar region, whilst the induction points are located in the incisor region.

It is known to position the upper jaw model with reference to a virtual plane by means of the cranial reference points of the upper jaw. Moreover, it is known to position the lower jaw model by means of the cranial reference points of the lower jaw with reference to a virtual plane. The position of the upper jaw model and the lower jaw model with respect to the virtual reference planes thereof results from empirical surveys on test subjects. However, this means that individual positioning, tuned to the person in question, of the lower jaw relative to the upper law cannot be achieved, and so the dentition having the conventionally produced dental prosthesis generally has mispositioning of the temporomandibular joint.

### SUMMARY OF THE INVENTION

The object of the invention is to provide a method for producing a dental and/or bone prosthesis for a dentition having a defect and a template body and a transfer device for producing the dental and/or bone prosthesis, the dental and/or bone prosthesis being configured in such a way that mispositioning in the temporomandibular joint is prevented in the dentition.

The method according to the invention for producing a dental and/or bone prosthesis for a dentition having a defect, the dentition comprising an upper jaw and a lower jaw, comprises the steps of: determining the left and right direction point and an induction point of the upper jaw as three cranial reference points of the upper jaw and determining the left and right direction point and an induction point of the lower jaw as three cranial reference points of the lower jaw, the time when the six cranial reference points are determined being a time when the defect is not yet present; storing the relative spatial position of the cranial reference points, in such a way that the spatial position of the six cranial reference points with respect to one another is completely defined; creating a model of the defective dentition, one model half being produced for the upper jaw and one model half being produced for the lower jaw; identifying the three cranial reference points of the upper jaw on the upper jaw model half and identifying the three cranial reference points of the lower jaw on the lower jaw model half; arranging and fixing the upper jaw model half and the lower jaw model half relative to one another, in such a way that the spatial position of the six cranial reference points relative to one another corresponds to the stored spatial position; forming the dental and/or bone prosthesis by means of the model halves which are spatially fixed relative to one another, in such a way that the spatial position of the six cranial reference points is maintained.

Particularly disclosed is a method for producing a dental and/or bone prosthesis for a dentition having a defect, the dentition comprising an upper jaw and a lower jaw, comprises the steps of: determining the left and right direction point and an induction point of the upper jaw as three cranial reference points of the upper jaw and determining the left and right direction point and an induction point of the lower jaw as three cranial reference points of the lower jaw, the time when the six cranial reference points are determined being a time when the defect is not yet present; storing the relative spatial position of the cranial reference points, in such a way that the spatial position of the six cranial reference points with respect to one another is completely defined; creating a model of the defective dentition, one model half being produced for the upper jaw and one model half being produced for the lower jaw; identifying the three cranial reference points of the upper jaw on the upper jaw model half and identifying the three cranial reference points of the lower jaw on the lower jaw model half; arranging and fixing the upper jaw model half and the lower jaw model half relative to one another, in such a way that the spatial position of the six cranial reference points relative to one another corresponds to the stored spatial position; forming the dental and/or bone prosthesis by means of the model halves which are spatially fixed relative to one another, in such a way that the spatial position of the six cranial reference points is maintained and wherein a template body is formed for storing the relative spatial position of the six cranial reference points, the vertices of the template body coinciding with the coordinates of the six cranial reference points.

It is preferred for the induction point of the upper jaw to be the front induction point and the induction point of the lower jaw to be the front induction point or for the induction point of the upper jaw to be the rear induction point and the induction point of the lower jaw to be the rear induction point. It is further preferred for the relative spatial position of the six cranial reference points to be defined by the upper plane, which is spanned by the cranial reference points of the upper jaw, and the lower plane, which is spanned by the cranial reference points of the lower jaw, and by the distances from the two planes of the left intersection point, at which the straight line from the left upper direction point to the lower induction point and the straight line from the left lower direction point to the upper induction point intersect, and by the distances from the two planes of the right intersection point, at which the straight line from the right upper direction point to the lower induction point and the straight line from the right lower direction point to the upper induction point intersect. In this context, it is preferred for the template body according to the invention, the vertices of which coincide with the coordinates of the six cranial reference points, to be formed to store the relative spatial position of the six cranial reference points. The edges of the template body are preferably formed by the straight line from the left upper direction point to the lower induction point, the straight line from the left lower direction point to the upper induction point, the straight line from the right upper direction point to the lower induction point and the straight line from the right lower direction point to the upper induction point.

Alternatively, it is preferred for the relative spatial position of the six cranial reference points to be defined by three spatial coordinates of each of the six cranial reference points.

Moreover, determining the cranial reference points is preferably performed by an imaging method, in particular by a digital volume tomography method.

The template body according to the invention is provided for storing the relative spatial position of the six cranial reference points of the dentition, the vertices of the template body coinciding with the spatial coordinates of the six cranial reference points of the dentition.

Preferably, edges of the template body are formed by the straight line from the left upper direction point to the lower induction point, the straight line from the left lower direction point to the upper induction point, the straight line from the right upper direction point to the lower induction point and the straight line from the right lower direction point to the upper induction point. It is further preferred for the template body to comprise the left intersection point and the right intersection point, the left intersection point being on the edge from the left upper direction point to the lower induction point and the edge from the left lower direction point to the upper induction point, and the right intersection point being on the edge from the right upper direction point to the lower induction point and the edge from the right lower direction point to the upper induction point.

The transfer device according to the invention is provided for arranging the upper jaw model half relative to the lower jaw model half, and comprises the template body, a gripping device having at least three gripping prongs projecting from the gripping device, and a holder to which the gripping device can be attached and by means of which the gripping device is movably mounted, in such a way that cranial reference points of the upper jaw model half and the lower jaw model half and vertices of the template body can be gripped by means of the gripping prongs.

The holder preferably comprises a holding rail, on the longitudinal ends of which the gripping device can be detachable reciprocally attached. It is further preferred for the holder to comprise a mounting for mounting the holding rail, which is set up in such a way that the holding rail is movable vertically and horizontally in the longitudinal direction and perpendicular to the longitudinal direction. Further, the gripping device is preferably a gripping fork, and further, the transfer device preferably comprises a second gripping fork having at least three gripping prongs by means of which the gripping prongs of the first gripping fork can be gripped. In this context, it is preferred for the holder to comprise a second holding rail, on one longitudinal end of which the second gripping fork is attached, and for the holder to comprise a mounting for mounting the second holding rail, which is set up in such a way that the second holding rail is movable vertically and horizontally in the longitudinal direction and perpendicular to the longitudinal direction.

At the reference time, from the end of the person's bone growth at approximately 18 years, the dentition can be determined by an imaging method and the cranial reference points can be determined. At this age, an arrangement of the person's jaw can generally be assumed in which mispositioning of the jaw as a result of wear has not yet noticeably occurred. At the age when the cranial reference points are to be determined, the defect of the dentition should not yet be present. Using the stored spatial position of the cranial reference points, the relative association of the lower jaw with the upper jaw in the ideal position is now available for the person. If a defect of the dentition should set in during the person's lifetime, and mean that the lower jaw is no longer in the ideal position relative to the upper jaw, this ideal position can be reproduced according to the invention with the aid of the cranial reference points of the dentition, which is subsequently provided with the dental and/or bone prosthesis. As a result, the person having the dental and/or bone prosthesis has his/her lower jaw repositioned relative to the upper jaw, any mispositionings of the temporomandibular joint which may have occurred previously being corrected. As a result, damage to the entire joint and spinal column system, craniomandibular dysfunctions (CMDs) and associated muscular tensions and headaches resulting from the mispositionings may be eliminated, increasing the person's sense of wellbeing.

The straight lines connecting the direction points of the upper jaw to the induction point of the lower jaw and the straight lines connecting the direction points of the lower jaw to the induction point of the upper jaw form a triangle each, the limbs of which cross at the intersection points. The position of the intersection points relative to the direction points and the induction points does not change over the person's lifetime, and so the optimum three-dimensional association of the lower jaw with the upper jaw is always defined by the position of the intersection points. The vertices of the template body fixedly define the cranial reference points, which can thus be called up at any time if the template body is kept.

The method according to the invention is particularly successful when positioning teeth in full denture, in which the entire rows of teeth of each of the upper jaw and the lower jaw are to be reproduced. By the method according to the invention, tooth shapes, the height of bite, the tooth positions and the positions of the dental and/or bone prosthesis can be set in such a way that the person having the dental and/or bone prosthesis obtains an optimal alignment of the temporomandibular joint again. As a result, it is easy for the person to become accustomed to the dental and/or bone prosthesis, since the dental and/or bone prosthesis is optimally adapted to the anatomical parameters.

### DESCRIPTION OF THE DRAWINGS

In the following, the invention is explained in greater detail with reference to the appended schematic drawings, in which:

FIG. 1 is a three-dimensional drawing of a template body,

FIGS. 2 to 5 show a transfer device, with details for arranging an upper jaw model half relative to a lower jaw model half, and

FIGS. 6 to 9 show steps of a method for producing a dental prosthesis using the transfer device from FIGS. 2 to 5.

### DETAILED DESCRIPTION OF THE INVENTION

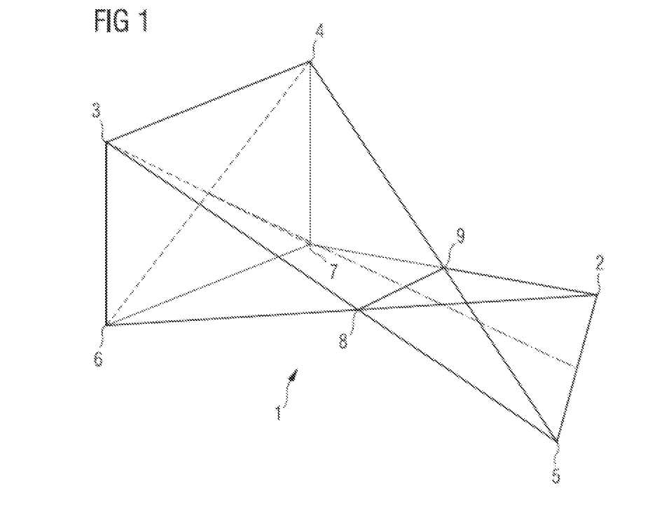

As can be seen from FIG. 1, a template body 1 has six corners. The spatial position of the six corners corresponds to the spatial position of six cranial reference points 2 to 7 of a dentition of a person whose bone growth has just ended. This is the case for most people at the age of approximately 18 years. The spatial coordinates of the cranial reference points 2 to 7 of the dentition may for example be determined by means of templates or an imaging method.

The six corners of the template body 1 correspond to the six cranial reference points 2 to 7. As shown in FIG. 1, the first cranial reference point is an upper induction point 2 of an upper jaw, the second cranial reference point is the left upper direction point 3 of the upper jaw, the third cranial reference point is a right upper direction point 4 of the upper jaw. Further, the fourth cranial reference point is a lower induction point 5 of a lower jaw, the fifth cranial reference point is the left lower direction point 6 of the lower jaw, and the sixth cranial reference point is a right lower direction point 7 of the lower jaw. A first edge of the template body 1 is formed by the straight line from the left upper direction point 3 to the lower induction point 5, a second edge of the template body is formed by the straight line from the left lower direction point 6 to the upper induction point 2. The first edge and the second edge intersect at a left intersection point 8. Further, a third edge of the template body 1 is formed by the straight line from the right upper direction point 4 to the lower induction point 5, and a fourth edge of the template body 1 is formed from the right lower direction point 7 to the upper induction point 2. The third edge and the fourth edge intersect at a right intersection point 9.

The relative spatial position of the intersection points 8 and 9 with respect to the cranial reference points 2 to 7 remains unchanged, and defines the position of the lower jaw of the dentition relative to the upper jaw of the dentition. In general, the position of the intersection points 8 and 9 is individual to every person. Since the template body 1 is formed individually for the person, the template body 1 stores the position of the lower jaw relative to the upper jaw for the state of the dentition where it does not yet have a defect and the jaws are spatially positioned optimally relative to one another. The template body 1 now stores the individual optimal alignment of the jaws for the person's stage of life in which for example age-related defects and thus mispositionings of the jaws set in.

For a dentition having a defect, the spatial positions of the current cranial reference points can be determined. Comparing the spatial position of each cranial reference point with the corners of the template body 1 gives the degree of mispositioning of the jaw which is brought about by the defect of the dentition.

A dental and/or bone prosthesis by means of which the defect of the dentition can be compensated is to be provided for the dentition. The dental prosthesis may for example be an individual tooth, part of a tooth or a full denture. When the dental prosthesis is produced, a dentition model 10 of the dentition is produced, the upper jaw being modelled using an upper jaw model half 11 and the lower jaw being modelled using a lower jaw model half 12. The jaw, together with the temporomandibular joint, is modelled in a jaw model 13, the upper jaw model half 11 and the lower jaw model half 12 being held by the jaw model 13 and being connected via the temporomandibular joint model.

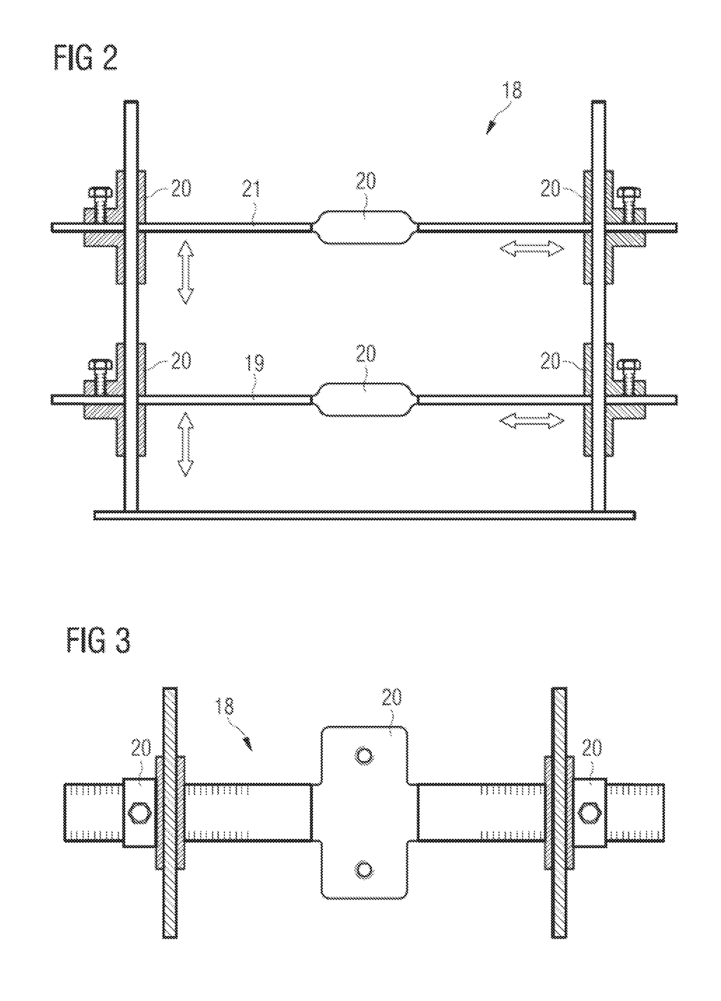

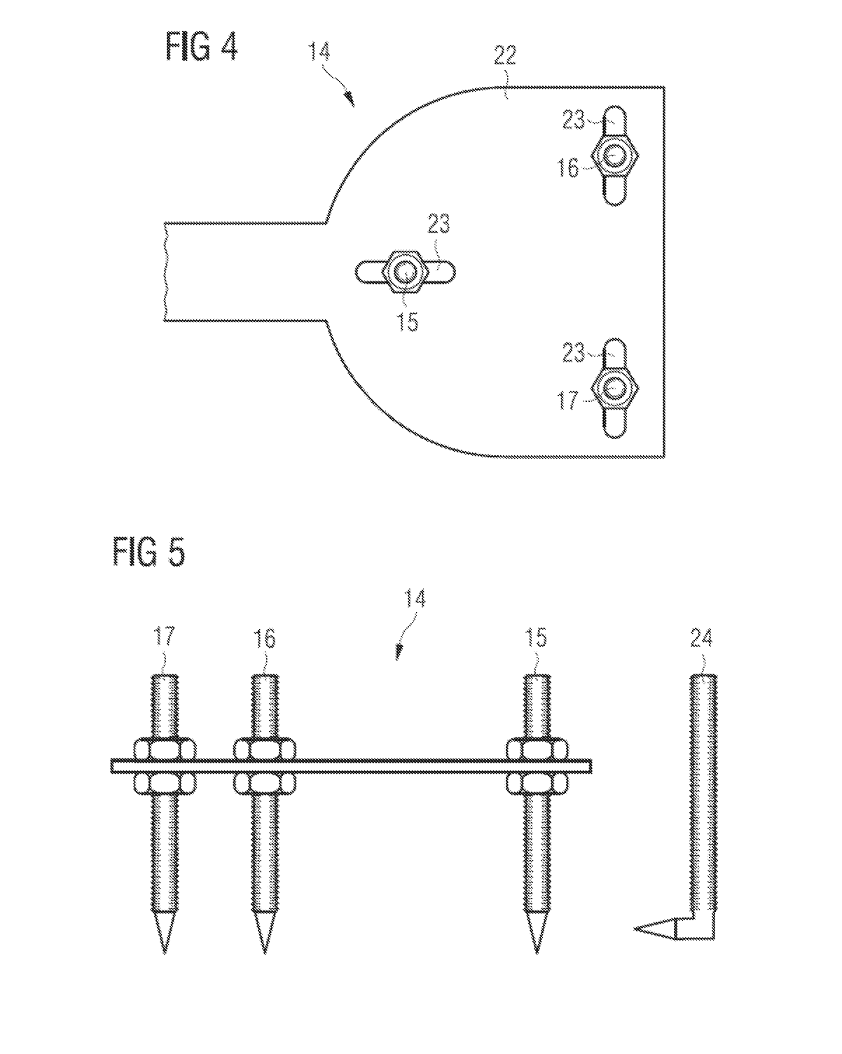

FIGS. 2 to 5 show a transfer device for arranging the upper jaw model half 11 and the lower jaw model half 12. The transfer device comprises a gripping fork 14, which comprises a first gripping prong 15, a second gripping prong 16 and a third gripping prong 17. The gripping prongs 15 to 17 are in the form of threaded bars, which taper to a point and which are screwed rigidly, extending mutually parallel, into slots 22 in a plate 22 of the gripping fork 14, the tips of the gripping prongs 15 to 17 pointing in the same direction. Further, a fourth gripping prong 24 is provided, which is L-shaped and can be installed in the slot 23 for the first gripping prong 15 as a replacement for the first gripping prong 15. Nuts, by means of which the gripping prongs 15 to 17 and 24 can be screwed rigidly into the associated slots 23 thereof in the plate 22, are provided for the gripping prongs 15 to 17 and 24.

The transfer device further comprises a holder 18 and two holding rails 19 and 21, which are each mounted vertically displaceably on vertical columns of the transfer device by means of a mounting 20. A mounting 20, by means of which the gripping fork 14 can be fixed to and mounted horizontally displaceably on the holding rails 19 and 21, is provided on each of the holding rails 19 and 21. Since the holding rails 19 and 21 are horizontally displaceable on the columns, the gripping fork 14 is vertically displaceable on the holding rails 19 and 21, and the gripping prongs 15 to 17 and 24 are displaceable in the slots 23 transverse and parallel to the plate 22, the spatial position of the tips of the gripping prongs 15 to 17 and 24 can be adjusted.

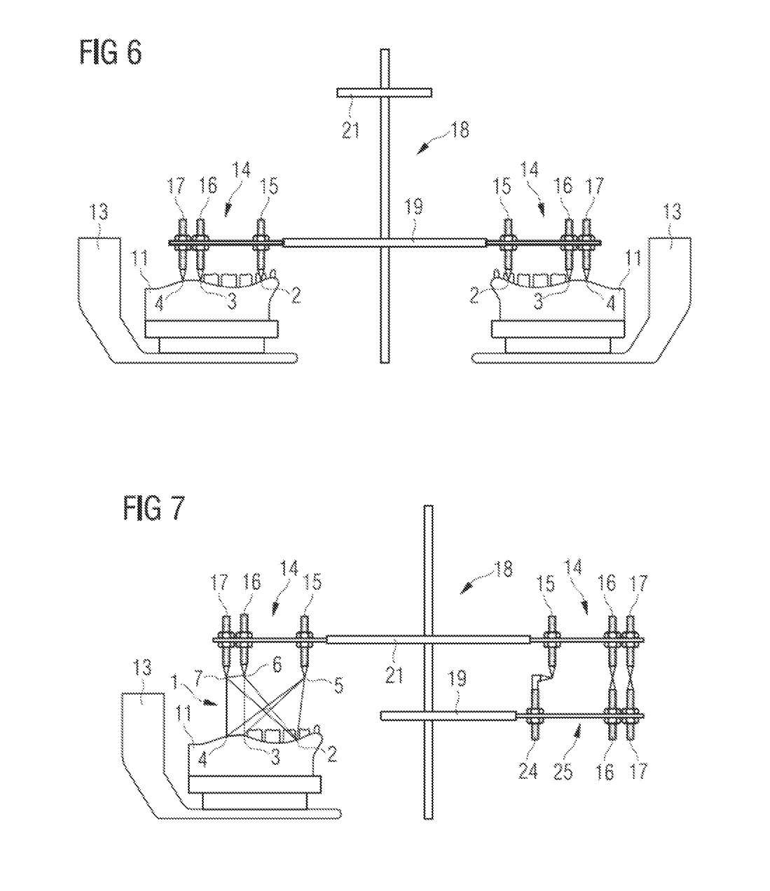

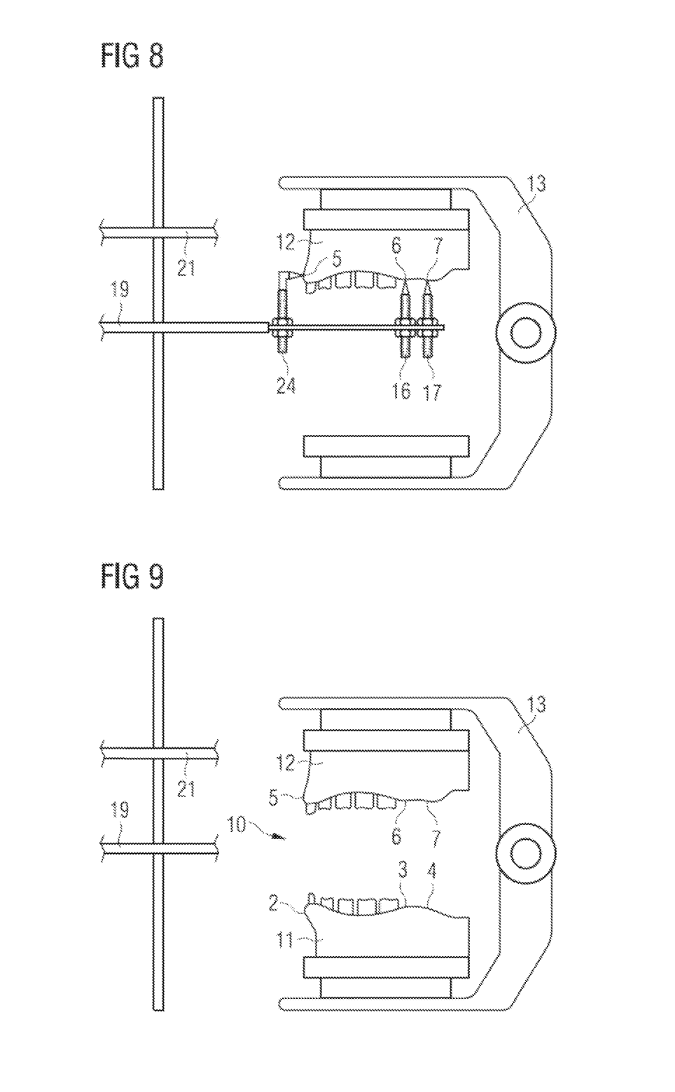

To arrange the upper jaw model half 11 relative to the lower jaw model half 12 in the jaw model 13, in a first step the upper jaw model half 11 is articulated in and laid on the transfer device in a first position (left in FIG. 6), the teeth of the upper jaw model 11 being accessible from above. On the upper jaw model half 11, the cranial reference points 2 to 4 are identified, for example by applying a template, independent of the rows of teeth, of the upper jaw, having corresponding markings of the cranial reference points from a starting memory. The gripping fork 14 is attached to the first holding rail 19 by means of the mounting 20, and the gripping prongs 15 to 17 are positioned in the slots 23 thereof and attached to the plate 22, in such a way that the tips of the gripping prongs 15 to 17 each contact one of the cranial reference points 2 to 4. The first gripping prong 15 is provided for the upper induction point 2, the second gripping prong 16 is provided for the left upper direction point 3, and the third gripping prong 17 is provided for the right upper direction point 4.

Opposite the upper jaw model half 11, and substantially as the mirror inverse of the first holding rail 19, in a second step a working model, which is an imitation of the upper jaw model half 11 and to which corresponding markings of the cranial reference points from a starting memory are applied using a template, independent of the rows of teeth, of the upper jaw, is articulated in and laid in a second position on the transfer device. The working model corresponds to the upper jaw model half 11 and is an exact imitation thereof, individual teeth having to be deleted depending on the tooth inventory of the upper jaw model half 11, in such a way that the cranial reference points 2 to 4 of the upper jaw model half 11 are accessible to the template body 1. The working model 14 thus means that any deletions which may be necessary need not be applied to the upper jaw model half 11 itself. The gripping fork 14 is placed by the upper jaw model half 11 in the second position on the mounting 20. In this context, the working model is positioned in such a way that the gripping prongs 15 to 17 contact the cranial reference points 2 to 4 of the working model, just as they contacted the cranial reference points 2 to 4 of the upper jaw model half 11. Once the arrangement of the upper jaw model 11 or of the working model in the second position is finalised, the gripping fork 14 should be removed from the mounting 20.

In a third step, the template body 1 is laid on the working model, in such a way that the corners of the template body 1 contact the cranial reference points 2 to 4 of the upper jaw model half 11 which are assigned thereto. As a result, the corners of the template body 1 which are assigned to the cranial reference points 5 to 7 project upwards. The gripping fork 14 should now be fixed to the mounting 20 of the second holding rail 21, the second holding rail 21 being arranged above the first holding rail 19 and the gripping fork 14 being arranged above the template body 1. The gripping prongs 15 to 17 should be adjusted in such a way that the tips thereof contact the corners of the template body 1 which are assigned thereto. Thus, the first gripping prong 15 should contact the lower induction point 5, the second gripping prong 16 should contact the left lower direction point 6, and the third gripping prong 17 should contact the right lower direction point 7.

In a fourth step, the gripping fork 14 is removed from the mounting 20 of the upper holding rail 21 and applied again to the mounting 20 of the upper holding rail 21 opposite, in such a way that the gripping prongs 15 to 17 of the gripping fork 14 define the positions of the lower cranial reference points 5 to 7 of the lower jaw model half 12 in the first position. Since in anatomical terms the lower induction point 5 is in the conclusion plane of the dentition, it is not possible to apply the lower jaw model half 12 directly to the gripping prongs 15 to 17.

Thus, in a further gripping fork 25, the gripping prong for the lower induction point 5 is replaced by an angled gripping prong 24, the tip of which points towards the lower induction point 5. In a fifth step, the further gripping fork 25 is fixed to the mounting 20 of the first holding rail 19, and the gripping prongs 16, 17 and 24 of the further gripping fork 25 are brought into position, in such a way that the tips of the gripping prongs 16, 17, 24 contact the tips of the gripping prongs of the upper gripping fork 14 and project upwards.

In an intermediate step, the gripping fork is now removed from the mounting 20 of the holding rail 21 so as to make space for articulation into the jaw model 13 from the first position. Now, for a sixth step, the lower jaw model half 12 having the corresponding markings of the cranial reference points from the starting memory of a template, independent of the rows of teeth, of the lower jaw is to be aligned with the lower cranial direction points 6 and 7 and the lower cranial induction point 5 using tips of the gripping prongs 16, 17 and 24 and articulated into the jaw model lower part of the jaw model 13. Subsequently, in a further intermediate step, the gripping fork 25 is removed from the mounting 20 of the first holding rail 19 and the articulated-in upper jaw model half 11 from the first step is inserted into the jaw model upper part of the jaw model 13, which is again arranged in the first position from the first step.

In accordance with an alternative embodiment of the transfer system, the first step is identical to the previously disclosed embodiment when the upper jaw model half 11 is being arranged relative to the lower jaw model half 12. The lengths of the gripping prongs 15 to 17 are now set to a defined length. In the following step, the template body 1 is positioned on the tips of the gripping prongs 15 to 17, which determine the cranial reference points 2 to 4, in such a way that the corners of the template body 1 mirror the cranial reference points 2 to 4 of the upper jaw model half 11 which are assigned thereto. As a result, the corners of the template body 1 which are assigned to the cranial reference points 5 to 7 project upwards.

In a second step, the gripping fork 14 should be fixed in the mounting 20 of the second holding rail 21, the second holding rail 21 being arranged above the first holding rail 19 and the gripping fork 14 being arranged above the template body 1. The gripping prongs 15 to 17 are to be adjusted in such a way that the tips thereof contact the corners of the template body 1 which are assigned thereto. Thus, the first gripping prong 15 should contact the lower induction point 5, the second gripping prong 16 should contact the left lower direction point 6, and the third gripping prong 17 should contact the right lower direction point 7.

A third step involves the same procedure as in the fourth step of the embodiment disclosed above, except that the gripping fork 14 need not be removed from the mounting 20 and repositioned, since the cranial reference points 5 to 7 are only transferred on one side of this transfer system. The gripping prongs 15 to 17 of the gripping fork 14 define the positions of the lower cranial reference points 5 to 7 of the lower jaw model half 12 in the first position. Since in anatomical terms the lower induction point 5 is in the conclusion plane of the dentition, it is not possible to apply the lower jaw model half 12 directly to the gripping prongs 15 to 17.

Thus, using the further gripping fork 25, the gripping prong 15 for the lower induction point 5 is replaced by the angled gripping prong 24, the tip of which points towards the induction point 5. In a fourth step, the further gripping fork 25 is fixed to the mounting 20 of the first holding rail 19, and the gripping prongs 16, 17 and 24 of the further gripping fork 25 are brought into position, in such a way that the tips of the gripping prongs 16, 17, 24 contact the tips of the gripping prongs of the upper gripping fork 14 and project upwards.

A fifth step involves displacing the holding rail 19 downwards by the fixed length of the gripping prongs 16, 17, 24. As a result, the position of the upper jaw model half 11 relative to the lower jaw model half 12 is set to the original relationship, since it has been mirrored vertically upwards by the fixed length of the gripping prongs 16, 17, 24 in the first step.

The sixth step is identical to the sixth step of the previously disclosed embodiment and starts with an intermediate step, in which the gripping fork 14 is removed from the mounting 20 of the holding rail 21 so as to make space for articulation into the jaw model 13 from the first position. Now, for this step, the lower jaw model half 12 having the corresponding markings of the cranial reference points from the starting memory of a template, independent of the rows of teeth, of the lower jaw is to be aligned with the lower cranial direction points 6 and 7 and the lower cranial induction point 5 using the tips of the gripping prongs 16, 17 and 24 and articulated into the jaw model lower part of the jaw model 13. Subsequently, in a further intermediate step, the gripping fork 25 is removed from the mounting 20 of the first holding rail 19 and the articulated-in upper jaw model half 11 from the first step is inserted into the jaw model upper part of the jaw model 13, which is again arranged in the first position from the first step.

Care should be taken that the position of the upper jaw model 11 in the jaw model 13 with respect to the transfer device is reproducible. This may for example be achieved using recesses in a horizontal underlay, by means of which recesses both the arrangement of the jaw model 13 and the arrangement of the transfer system are determined, or by providing corresponding register pins having associated holes between the underlay and the jaw model 13 and between the underlay and the transfer system.

Thus, after the steps have been carried out, positioning of the lower jaw model half 11 relative to the upper jaw model half 12 is achieved, the cranial reference points 2 to 7 of the dentition being arranged in the positions thereof relative to one another as defined by the template body 1. Thus, by means of the transfer device, the person's original bite at the reference time of approximately 18 years can be determined using the template body 1. It is also conceivable to simulate the transfer in a computer-assisted manner using the template body 1 and the jaw model halves 11, 12, in such a way that the steps are carried out virtually.

A dental prosthesis for the dentition can now be produced on the basis of the jaw model halves 11, 12 which are arranged relative to one another, the dentition comprising the dental prosthesis having a bite which corresponds to the person's original bite at the reference time of approximately 18 years.

### LIST OF REFERENCE NUMERALS

1 Template body

2 First cranial reference point, upper induction point

3 Second cranial reference point, left upper direction point

4 Third cranial reference point, right upper direction point

5 Fourth cranial reference point, lower induction point

6 Fifth cranial reference point, left lower direction point

7 Sixth cranial reference point, right lower direction point

8 Left intersection point

9 Right intersection point

10 Dentition model

11 Upper jaw model half

12 Lower jaw model half

13 Jaw model

14 Gripping fork

15 First gripping prong

16 Second gripping prong

17 Third gripping prong

18 Holder

19 First holding rail

20 Mounting

21 Second holding rail

22 Plate

23 Slot

24 Fourth gripping prong

25 Further gripping fork

1. A method for producing a dental and/or bone prosthesis for a dentition having a defect, the dentition comprising an upper jaw and a lower jaw, comprising the steps of:
determining the left and right direction point (3, 4) and an induction point (2) of the upper jaw as three cranial reference points of the upper jaw and determining the left and right direction point (6, 7) and an induction point (5) of the lower jaw as three cranial reference points of the lower jaw, the time when the six cranial reference points (2 to 7) are determined being a time when the defect is not yet present;
storing the relative spatial position of the six cranial reference points (2 to 7), in such a way that the spatial position of the six cranial reference points (2 to 7) with respect to one another is completely defined;
creating a model (10) of the defective dentition, one model half (11) being produced for the upper jaw and one model half (12) being produced for the lower jaw;
identifying the three cranial reference points (2 to 4) of the upper jaw on the upper jaw model half (11) and identifying the three cranial reference points (5 to 7) of the lower jaw on the lower jaw model half (12);
arranging and fixing the upper jaw model half (11) and the lower jaw model half (12) relative to one another, in such a way that the spatial position of the six cranial reference points (2 to 7) relative to one another corresponds to the stored spatial position;
forming the dental and/or bone prosthesis by means of the model halves which are spatially fixed relative to one another, in such a way that the spatial position of the six cranial reference points (2 to 7) is maintained,
wherein a template body (1) is formed for storing the relative spatial position of the six cranial reference points (2 to 7), the vertices of the template body coinciding with the coordinates of the six cranial reference points (2 to 7).

2. The method according to claim 1, wherein the induction point of the upper jaw is the front induction point (2) and the induction point of the lower jaw is the front induction point (5), or the induction point of the upper jaw is the rear induction point and the induction point of the lower jaw is the rear induction point.

3. The method according to claim 1, wherein the relative spatial position of the six cranial reference points (2 to 7) is defined by the upper plane, which is spanned by the cranial reference points (2 to 4) of the upper jaw, and the lower plane, which is spanned by the cranial reference points (5 to 7) of the lower jaw, and by the distances from the two planes of the left intersection point (8), at which the straight line from the left upper direction point (3) to the lower induction point (5) and the straight line from the left lower direction point (6) to the upper induction point (2) intersect, and by the distances from the two planes of the right intersection point (9), at which the straight line from the right upper direction point (4) to the lower induction point (5) and the straight line from the right lower direction point (7) to the upper induction point (2) intersect.

4. The method according to claim 1, wherein edges of the template body are formed by the straight line from the left upper direction point (3) to the lower induction point (5), the straight line from the left lower direction point (6) to the upper induction point (2), the straight line from the right upper direction point (4) to the lower induction point (5) and the straight line from the right lower direction point (7) to the upper induction point (2).

5. The method according to claim 1, wherein the relative spatial position of the six cranial reference points (2 to 7) is defined by three spatial coordinates of each of the six cranial reference points.

6. The method according to claim 1, wherein determining the cranial reference points (2 to 7) is performed by an imaging method, in particular by a digital volume tomography method.

7. A template body for storing the relative spatial position of six cranial reference points (2 to 7) of a dentition, wherein the vertices of the template body (1) coincide with the spatial coordinates of the six cranial reference points (2 to 7) of the dentition.

8. The template body according to claim 7, wherein edges of the template body are formed by the straight line from the left upper direction point (3) to the lower induction point (5), the straight line from the left lower direction point (6) to the upper induction point (2), the straight line from the right upper direction point (4) to the lower induction point (5) and the straight line from the right lower direction point (7) to the upper induction point (2).

9. The template body according to claim 7, wherein the body comprises a left intersection point (8) and a right intersection point (9), the left intersection point (8) being on the edge from the left upper direction point (3) to the lower induction point (5) and the edge from the left lower direction point (6) to the upper induction point (2), and the right intersection point (9) being on the edge from the right upper direction point (4) to the lower induction point (5) and the edge from the right lower direction point (7) to the upper induction point (2).

10. A transfer device for arranging an upper jaw model half (11) relative to a lower jaw model half (12), comprising a template body (1) according to claim 8, a gripping device (14) having at least three gripping prongs (15 to 17) projecting from the gripping device (14), and a holder (18) to which the gripping device (18) can be attached and by means of which the gripping device (14) is movably mounted, in such a way that cranial reference points (2 to 7) of the upper jaw model half (11) and the lower jaw model half (12) and vertices of the template body (1) can be gripped by means of the gripping prongs (15 to 17).

11. The transfer device according to claim 11, wherein the holder (18) comprises a holding rail (19), on the longitudinal ends of which the gripping device can be detachable reciprocally attached.

12. The transfer device according to claim 11, wherein the holder (18) comprises a mounting (20) for mounting the holding rail (19), which is set up in such a way that the holding rail (19) is movable vertically and horizontally in the longitudinal direction and perpendicular to the longitudinal direction.

13. The transfer device according to claim 11, wherein the gripping device is a gripping fork (14), and the transfer device comprises a second gripping fork (15) having at least three gripping prongs (16, 17, 24) by means of which the gripping prongs (15 to 17) of the first gripping fork (14) can be gripped.

14. The transfer device according to claim 11, wherein the holder (18) comprises a second holding rail (21), on one longitudinal end of which the second gripping fork (25) is attached, and the holder comprises a mounting for mounting the second holding rail (21), which is set up in such a way that the second holding rail (21) is movable vertically and horizontally in the longitudinal direction and perpendicular to the longitudinal direction.
